(19) United States
(12) Patent Application Publication
(10) Pub. No.: US 2022/0272119 A1
(43) Pub. Date: Aug. 25, 2022

(54) PROTECTION SYSTEM OF INFORMATION NETWORKS AND RELEVANT SECURITY PROCEDURE

(71) Applicant: CYBER EVOLUTION S.R.L., Ascoli Piceno (IT)

(72) Inventor: Roberto CAMERINESI, Monsampolo Del Tronto (AP) (IT)

(21) Appl. No.: 17/629,699

(22) PCT Filed: Apr. 5, 2020
(86) PCT No.: PCT/EP2020/072043

§ 371 Date: Jan. 24, 2022

(30) Foreign Application Priority Data
Aug. 7, 2019 (IT) 102019000014295

(51) Int. Cl. H04L 9/40

(52) U.S. Cl. CPC H04L 63/1441

(57) ABSTRACT

Disclosed is a security system against an attack and/or cyber threat carried out over an information network having at least one or more hosts and/or one or more clients and possibly connected to an Internet network and/or other types of networks. The security system is able to recognize the attack and/or cyber threat and to implement a consequent countermeasure. The security system constitutes one of the clients and has a connection to the information network, an electrical supply thereof, at least one socket adapted to the electrical connection of one or more of the hosts and/or clients of the same information network and an electrical supply cutoff for the one or more hosts and/or clients connected thereto.

The present invention relates to an innovative system for the control and the protection of a network for the exchange of data and messages.

More precisely, the present invention relates to a protection device against cyber attacks that can be carried out over information networks or systems to steal sensitive data and secret information or to tamper and destroy the relevant assets and information devices.

Therefore, the invention relates to the field of information security, that is to say to the field of devices, hardware and/or software, for the protection of an information network against threats, such as malware or attacks that are “physically” carried out by an attacker (also known as “cracker” or “black-hat”).

For the sake of simplicity, the term “information network” will be hereinafter used to indicate any set of nodes interconnected by communication channels to exchange data and message, defined for instance according to the Wireless Ethernet 802.11 standard.

In particular, without any limiting purposes, reference will be made to an information network characterized by a set of electronic and/or digital hardware devices connected by means of suitable channels (links, network cables, Wi-Fi, Bluetooth and the like) that permit the exchange and sharing of data and the communication between multiple users or distributed terminals.

Said information network may be possibly connected to other similar networks and/or sub-networks (i.e. a computer network) and/or to an external network (i.e. the Internet) according to specific requirements and different topologies.

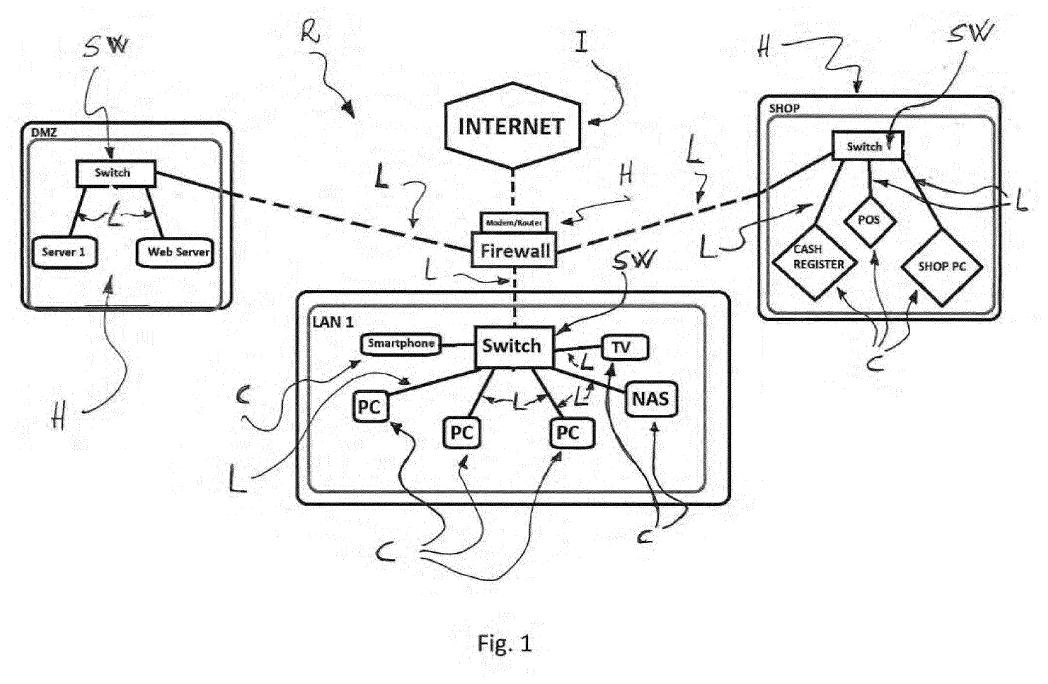

For illustrative purposes, FIG. 1 shows a typical network architecture R composed of an external network I, for instance an Internet network, connected to one or more hosts H (i.e. one or more servers that provide a certain service or resource, such as software sharing) and clients C, such as computers, notebooks and laptops, workstations, cellular telephones, hand-held devices, web-TVs, thin clients or any other information device capable of accessing and communicating with said one or more servers.

A numerical label, known as “IP address”, together with the “MAC Address”, univocally identifies each one of said host H and/or client C devices of the network R.

Said typical architectures R may also comprise Network Switches and/or SW routers disposed between said hosts H and clients C and capable of addressing data packets along specific networks.

Suitable connections L connect said H, C, SW devices one with the other and to the network.

For the purposes of the present description, the term “malware” will indicate any program or threat able to compromise the functionality of an electronic device (i.e. a computer), steal sensitive or private information, transmit undesired or malicious publicity, and “map” a network, i.e. scan and analyze a network in order to identify its specific topology and detect possible leaks.

Likewise, the term “cracker” will indicate any “attacker” able to violate and access an information network illegally.

The modes of a cyber attack from malware or from an attacker are known; more precisely, such an attack occurs through a usual sequence of steps that can be described as follows:

1) searching the addresses of the systems (hosts H and/or clients C) that are open and active in an information network R, for instance through a scan process (also known as “port and/or host scan”), using specifically generated network packets or similar techniques;

2) more detailed enumeration of the hosts H and/or clients C of the network R identified as active from the scan process;

3) searching a vulnerability for the access and the violation of said active hosts H and/or clients C;

4) forcing the vulnerability and consequent attack to one or more of said host H and/or client C systems of the network R.

Moreover, it must be noted that at least the scanning step (step 1) that attempts to map a network R is substantially and generally carried out simultaneously among all its hosts H and/or clients C in the same subnetwork.

Therefore, protecting an information network against similar attacks and guaranteeing a suitable security level to the various devices and components of the information network is crucial.

Currently, the main security systems for the components of an information network comprise the so-called “firewalls” and/or IDS/IPS, as well as their respective subcategories.

As it is known, by using advanced technologies, a “firewall” (for example of hardware type) can carry out control and verification operations on the network packets that pass through it; if said packets comply with the rules and the requirements that are manually configured by the programmer or the installer, the firewall will let the network packet “pass”, otherwise the network packet will be blocked by the firewall.

Otherwise said, the firewalls of an information network operate as a sort of normally closed gate that opens only for the data flows that are recognized as safe.

For this reason, the firewalls are positioned and installed in the perimeter of any network topology, for instance between an internal network and an external network or between two internal networks, as clearly indicated in FIG. 1.

In order to improve their functionality, the most advanced firewalls can also implement artificial intelligence and machine learning algorithms, as well as cloud systems.

Instead, the IPSs/IDSs carry out a check and a detection of a potential information attack by acting from inside the information network and are therefore designed to inform anomalous situations and unauthorized intrusions (such as in the case of the IDSs) and/or block them (such as in the case of the IPSs) by means of a connection reset and/or by eliminating the malicious packets.

Whereas a firewall acts as perimeter filter of the information network and can be compared to a “gate” that opens only when certain rules are complied with, the IDSs/IPSs can be considered as a sort of alarm system inside the network.

The two aforementioned security systems, which have been used for a long time now, perform quite well, especially when used in combination; in such a case, in fact, it will be possible to filter the “attack carriers” (malicious packets and suspected traffic) already in the network perimeter and block the ones that have possibly accessed the network because of a failure of the firewall.

Notifications with emails, logs (memorization and visualization files of the data and information of the threat) or messages inform the user of the threat in real time in order to implement the consequent countermeasures such as, for example, the forced switching-off or the manual disconnection from the network of one or more of the attacked devices, the drop of the packets that are not recognized and/or are considered to be malicious and the consequent block of the sender of said packets.

With the currently available protection systems, however, said countermeasures are implemented tardily, i.e. when the first and/or second attack step has already occurred with the well-known negative consequences for the network and/or for one or more of its hosts or clients.

Moreover, the correct configuration of said protection systems requires technical skills in the field of networking, and an advanced knowledge of information security, which are seldom found in an average user.

Consequently, the optimal configuration of a firewall or an IDS/IPS may require the intervention of information technicians for a few workdays.

This contributes to increase the already high cost of purchasing, installing and maintaining such information security systems.

Furthermore, reliability is not optimal in the presence of new types of threat, known as “0-day” (which take advantage of vulnerabilities and/or use unknown attack methodologies), including cryptographic attacks, relative to network protocols, etc. It is therefore necessary to constantly and continuously update said security systems or purchase new, better performing “models” with an additional increase of management costs for the user.

In the case of complex networks, which are generally used in large corporations or in the “Large-scale Organized Distribution”, technologies such as VLAN, VPN are used in addition to the aforementioned system, as well as network devices that provide a more accurate programming, such as multi-level switches (i.e. the so-called L2/3 switches). Moreover, by using cryptography, virtual security channels can be created between the network and electronic devices that are difficult to be “spied” by malware or attackers.

The majority of the security systems against cyber threats are of “active” type, i.e. they are able to operate only with complex analyses and control operations on the data traffic over the network.

The purpose of the present invention is to eliminate the aforementioned problems by disclosing an innovative security system for information networks against attacks and threats that is inexpensive, easy to install and highly reliable.

An additional purpose of the present invention is to disclose a security system for information networks that is able to take a drastic action to protect the most delicate target hosts and/or clients during the first steps of a cyber attack.

Another purpose of the present invention is to disclose a security system for information networks of “Plug&Play” type that does not require additional configurations or specific knowledge in order to be installed by the user.

Furthermore, another purpose of the present invention is to disclose a security system for information networks that can be implemented in every existing Ethernet and can be possibly used in combination with the known firewalls and/or IDSs/IPSs to complete the security means of a network.

These and other purposes, which will appear manifest from the following description, are achieved with a security system for information networks as claimed in claim 1.

Additional purposes can be obtained with the supplementary characteristics of the dependent claims.

Further characteristics of the present invention will be apparent from the following description of some preferred embodiments, which are illustrated in the patent claims and shown for illustrative, not limiting purposes in the appended drawings, wherein:

FIG. 1 is a diagrammatic view of an information network of known type;

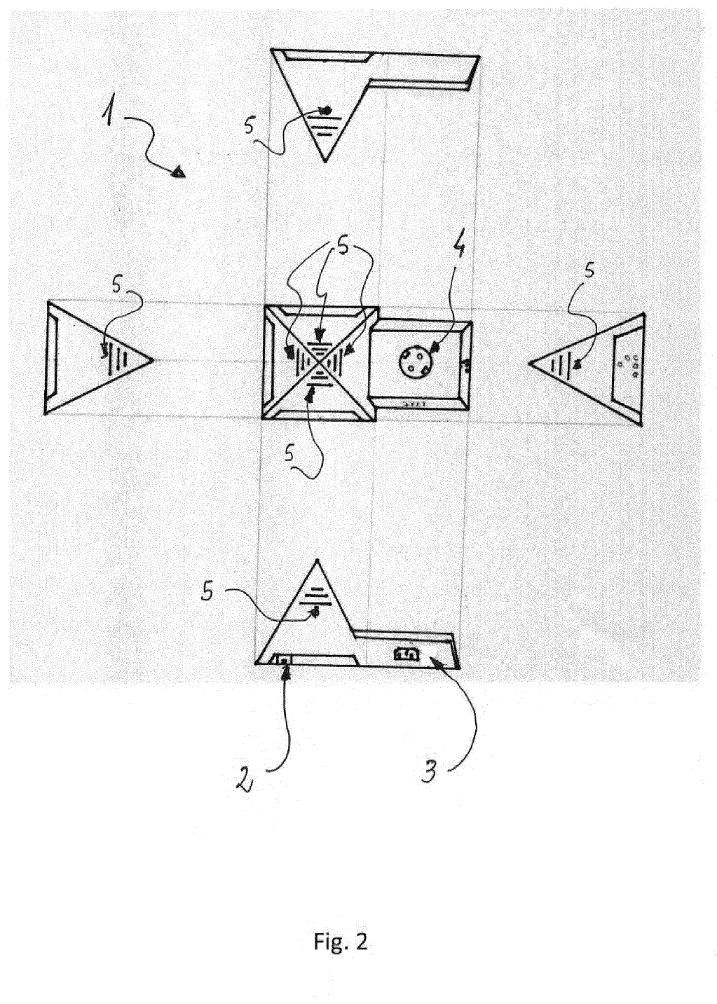

FIG. 2 shows the security system for information networks according to the invention, in different views.

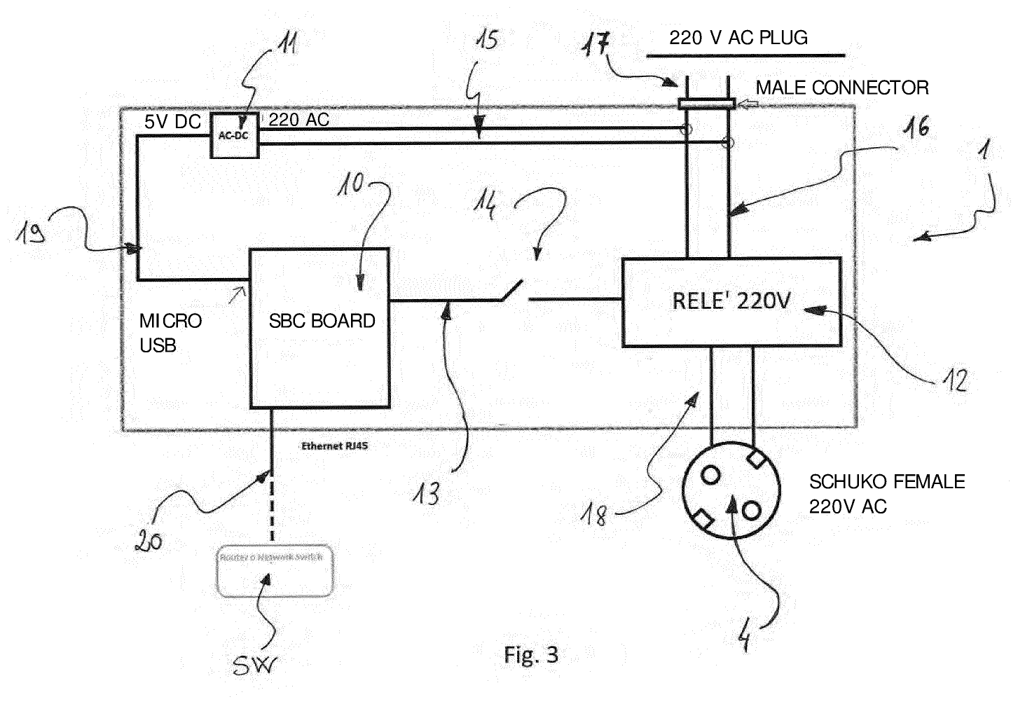

FIG. 3 is a diagrammatic view of the electrical and electronic connections of the security system for information networks of FIG. 2;

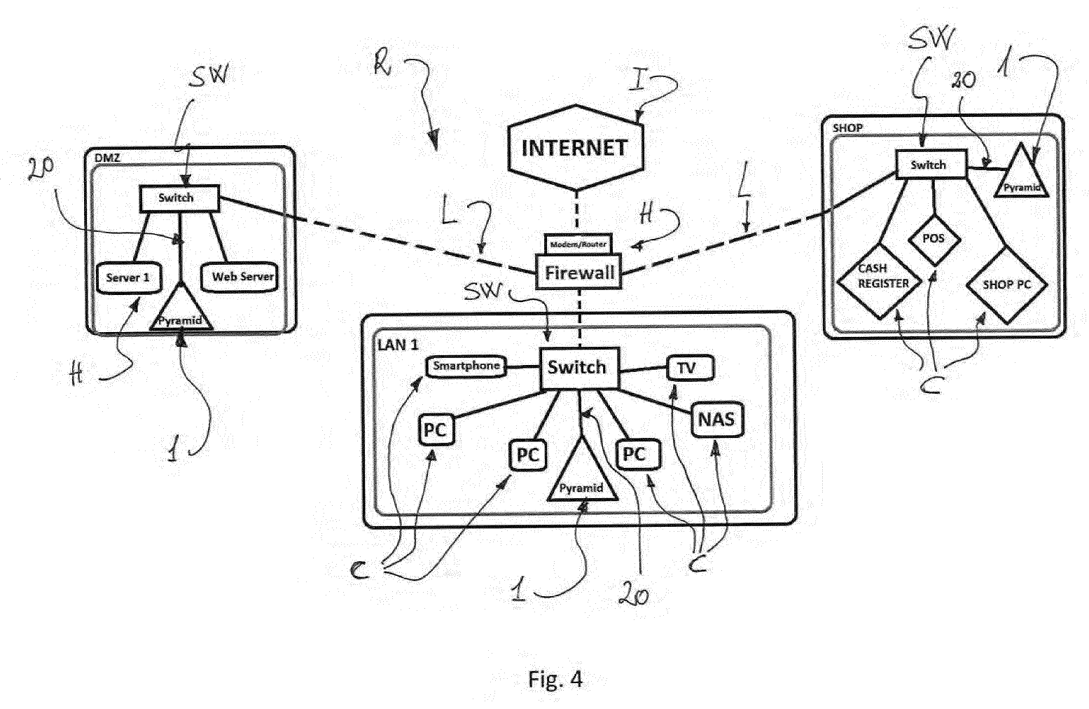

FIG. 4 shows the network of FIG. 1 with the implementation of the security system for information networks according to the invention.

The characteristics of the invention will be now described with reference to the Figures.

Firstly, it must be noted that the following description will refer to devices and protection/security systems that can be applied and used on information networks of any type and architecture; consequently, the example of FIG. 1, which has been partially described, is to be considered as a merely illustrative example, with no limiting purposes.

Otherwise said, the following description, which refers to an information network R that comprises at least one or more hosts H, relative clients C and switches SW that are possibly connected and cooperate with an external network (i.e. an Internet I or a “local” network), will also refer to any other network architecture of known type.

Moreover, the term “host” will indicate any type of servers or similar devices, whereas the term “client” will indicate generic electronic or information devices, such as, for illustrating, not limiting purposes, computers, notebooks, workstations, mobile devices (Smartphones, hand-held devices, tablets, e-readers, etc.) or videosurveillance devices, NASs, “smart objects” (i.e. IoT-compatible devices or objects), smart household appliance (i.e. for illustrating, not limiting purposes, washing machines and dishwashers, cooktops, extractor hoods and filtration hoods, boilers and water heaters, heat pumps, web-TVs or the like), domotics technologies, CNC machines for industrial use, automotive systems, automatic teller machines, and POS devices, cash registers, including new-generation RT models, or similar equipment.

With reference to FIG. 2, the security system for information networks against attacks and threats from software, such as malware, crackers and/or attackers, is indicated with reference numeral (1).

According to the invention, said security system 1 is directly integrated in an information network R (for instance, but not necessarily, of the type shown in FIG. 4) in order to monitor and protect one or more server H and/or client C devices of the information network, preferably the ones that are directly connected to the security system 1, as illustrated below.

Therefore, said security system 1 can be considered as a client of the information network R to be protected and is therefore characterized and identified with its own IP and MAC address.

Without any limiting purpose, as diagrammatically shown in FIG. 4, said security system 1 can be integrated in a LAN and/or DMZ network of known type and/or in any other network (i.e. of a shop, with clients, such as cash registers, also of RT type, POS and similar devices used for purchasing and payment operations) said networks, being possibly connected to an external Internet network I.

Preferably, one or more server H and/or client C devices can be connected to said security system 1, directly or by means of relative switches SW of known type (as shown in FIG. 4).

Advantageously, the system 1 is preferably a “stand alone” and “plug&play” device in order to be easily connected to the network, for example to said switches SW, and is able to:

recognize the first steps of a cyber attack that consists in the scan and in the successive enumeration of the IP addresses that are active in the network, operating in passive mode.

consequently implement an innovative countermeasure consisting in cutting-off the energy power (i.e. electrical power) of the servers H and/or clients C or any other devices, avoiding the diffusion of any virus, malware or cyber threat over the network and protecting the privacy and the security of said servers H and/or clients C or other devices.

Otherwise said, said security system 1 is technically suitable for recognizing a network scan by a malware or an attacker, said scan being simultaneously carried out on all devices H, C of the network.

Therefore, said security system 1 is suitably configured to:

passively “receive” one or more data packets addressed to the security system (1) or addressed in broadcast in the LAN, without making any active connection to other host and/or client servers,

“check” the data packets (which are intrinsically “anomalous” and representative of an attack because the system is passive and has no active connections to other hosts and/or clients characterized by an exchange of data packets), verifying whether they reflect a signature or pattern that is recognized as threat,

“energetically cut-off” and disconnect the servers H and/or clients C and/or other devices (i.e. networking devices) in case of detection of malicious packets.

According to a possible embodiment of the invention, the security system 1 can combine said energy cut-off with a suitable notification and alarm system of said detected threat, for example a light and/or sound notification, and/or an e-mail message, an SMS, a “local log file” or the like;

the notifications can be simultaneously sent also to other servers and/or clients of the network.

For the sake of clarity, a passive security system 1 is a client that does not make any active connection with any other device in the LAN during the ordinary conditions of operation and use, said system 1 being therefore involved in a complete data connection only when an attack or a cyber threat is received.

After a general presentation, this description continues illustrating the various components and the operation of the security system 1 of the invention in more detail.

As shown in FIG. 2, said security system 1 is preferably a box body with any shape, size and geometry, which comprises internal functional components, a plurality of ports and/or sockets that can be accessed externally and the relative connection circuitry; more precisely, said security system 1 may comprise at least:

means 2 for the connection to an information network R wherein it acts as client (see also FIG. 4) such as for instance a port 2 for a network cable 20 (i.e. Ethernet) and/or Wi-Fi® and/or Bluetooth® modules,

means 3 for the electrical supply comprising, according to the embodiment of FIG. 3, at least one port 3 for a connector 17, preferably of male type, for connection to the electrical mains (i.e. a wall socket),

at least one socket 4 (preferably of “female” type, indifferently “Schuko”, “Italian” or any other type available on the market) for the connection of one or more servers H and/or clients C of the same information network R.

As additionally shown in FIG. 3, the security system of the invention comprises at least one programmable SBC board 10 connected to a power supply 11 (preferably of 5 Volt-2 Ampere type) by means of micro-USB connectors 19 or the like.

Said board 10 preferably integrates an ARM processor (which guarantees low energy consumption for the requested quantity of calculation) and is normally connected to a router or to a network switch SW by means of said network cable 20 or Wi-Fi/Bluetooth modules.

Moreover, the programmable board 10 is connected to a relay 12 (i.e. a 220V 1-channel relay with 5V input in DC), with function and operating mode as described below.

More precisely, the programmable board 10 and the relay 12 are connected by means of a suitable cable 13 (defined as “relay cable”) comprising at least one normally closed ON/OFF switch 14.

The internal electrical circuitry of the security system 1 according to the present invention is completed by a pair of cables 15, 16, respectively for connecting the power supply 11 and the relay 12 to the connector 17, and an additional connection cable 18 of the relay 12 to the socket 4 for the one or more servers H and/or clients C or other devices of the network to be protected.

The electrical powering or cutting-off of the socket 4 and, consequently, of the various devices H, C connected to the socket 4,will depend on the close or open status of the switch 14 of the relay 12.

According to a possible executive variant of the invention, said means 3 for the electrical powering of the security system 1 of the invention may comprise batteries, possibly rechargeable batteries.

Such a solution appears advantageous for a temporary external use of the security system 1, for example for the protection of cash registers (also of RT type), POS devices or the like.

It is also possible to provide a “mixed” power supply, i.e. batteries for the programmable board 10 and electrical power supply for the socket 4, or vice versa.

Also in case of battery power, the energy cutting-off of the hosts H and/or clients C connected to the security system 1 will depend on the status of the relay or of similar switches with the same technical characteristics and the same operation mode.

For the aforementioned light and/or sound notifications generated by the security system 1 of the invention when a threat is detected, specific “notification devices” can be provided, such as LEDs, speakers or sirens.

In FIG. 2, the reference numeral 5 is used to indicate seats, slots or perforations for the housing and the correct operation of said notification devices.

For illustrative purposes, in case of anomalies in the network, the LEDs of the security system 1 can light up with a red light and/or can start flashing, whereas the siren can generate a specific sound, with different tone, volume and/or frequency according to the type and/or level of the detected threat; in view of the above, the user can immediately contact the technical service or take immediate action to neutralize the propagation of the cyber threat, if capable of doing it.

At software level, a suitable operating system, such as a linux Debian or one of its derivatives, is installed in the programmable board 10 of the security system 1.

At least one first control software of the data packets exchanged in the network is executed in said operating system, it being preferably based on the rules and modes of the firewalls or software security systems of known type.

More precisely, said first software is a “passive” program, i.e. a program that is not able to be interposed between a connection of servers H or clients C of the information network for a direct control; therefore, it operates as a sort of “trap”, awaiting the occurrence of a malicious event that is represented by a scan and/or enumeration process of the information network by a malware or an attacker.

Specifically, said first software can be an IDS (possibly with free license under GNU GPL) that monitors suspicious activities of network scanning or of connection requests from malware or an attacker, such as, for illustrating not limiting purposes, server H and/or client C enumerations, identification of the operating system or “forced login attempt”.

Based on the control and on the analysis of the data packets received from the network, if considered to be “malicious” (by means of algorithms and check modes of known type), said first software can activate a second software that manages said relay 12, specifically designed for opening the normally closed ON/OFF switch 14 (although, according to another variant, the opening can be controlled by the first software). Said management software sends a suitable signal to the relay 12. The relay 12 is excited and changes the status of the ON/OFF switch 14 from “normally closed” to “open”, thus energetically cutting-off the socket 4 of the security system 1 and the various server H and/or client C devices or the other devices connected to the socket 4.

Said software allows for detecting the scan of the information network R connected to the security system 1, interpreting such a scan as malicious, “switching-off” the various H, C devices connected to the system and disconnecting the power supply, thus avoiding the propagation and the advance of the attack towards said devices.

According to a possible embodiment of the invention, the security system 1 may also comprise one or more “false server processes” that are installed in the programmable board 10 and act as “honeypot”.

More specifically, said “false server processes” may consist in programs and/or services that can be executed in background and act as target for a malware or an attacker; otherwise said, the “false server processes” induce the malware or the attacker to violate the security system 1 of the invention rather than other hosts H and/or clients C of the information network that are simultaneously scanned.

For the sake of information, it must be additionally noted that the software installed in the security system 1 of the invention are also set to notify the detected malicious scanning via email, SMS or any text message and additionally activate the light and/or sound alarms, if any, as illustrated above.

Evidently, numerous variants of the aforementioned invention are possible for the experts of the field, without leaving the scope of novelty that are intrinsic in the inventive idea; likewise, in the practical implementation of the invention, the various aforementioned components can be replaced by technically equivalent elements.

For instance, in case of a detected threat, in addition to cutting-off and disconnecting the power supply of the various devices H, C, the security system 1 of the invention can:

communicate with other remote host and/or client devices over the network and/or via communication protocols of known type to start their security and automatic shutdown procedures via software,

inform the anomalies directly to the technical service.

Additional light sources integrated in the security system 1 of the invention can inform the presence or the absence of the Internet network signal, its status, possible malfunctioning or anomalies in the connections with the various network devices.

Finally, the security system 1 of the invention may also comprise a manual key (not shown in the figures) for the opening and/or the voluntary reset of said ON/OFF switch 14 of the relay 12 by the user.

Said key is provided and inserted in the relay cable 13 to manually disconnect or re-connect the power supply of the various host H and/or client C devices connected to the security system 1, and acts as an supplementary countermeasure in addition to the “automatic” countermeasure implemented by the software of the security system 1.

The security system 1 of the invention may also comprise an additional button (also known as “check button”) to manually check the status of the network connected to the security system 1, especially upon activation.

As a conclusion, it appears manifest that the purposes of the invention are achieved with the security system 1, with particular reference to the possibility of immediately detecting a cyber threat during the first attack steps, blocking its propagation to the various host and/or client devices in the network in an effective, quick and secure way, by cutting-off and disconnecting the power supply.

Moreover, said security system is inexpensive and easy to install, being of Plug&Play type, and does not require any additional configuration or technical skills by the user.

The security system 1 can be used in a number of different ways, can be implemented in any existing information network and can be possibly associated with the firewalls and IDSs/IPSs of known type.

1. Security system against an attack and/or cyber threat carried out over an information network comprising at least one or more hosts and/or one or more clients or other devices and possibly connected to an Internet network and/or other types of networks, said security system being able to recognize said attack and/or cyber threat and to implement a consequent countermeasure,
wherein said security system constitutes one of said one or more clients and comprises:
means for the connection to said information network,
means for the electrical supply thereof,
at least one socket adapted to the electrical connection of one or more of said hosts and/or clients of the same information network (R),
means for cutting-off the electrical supply for said one or more hosts and/or clients connected thereto,
said security system being a “passive” client, i.e. able to receive data packets without making active connections to other hosts and/or clients, said packets being considered as representative of said attack and/or cyber threat.

2. The security system of claim 1, wherein it comprises at least one notification system of said detected attack and/or cyber threat, said notification system comprising light and/or sound notification and/or e-mail and or SMS and/or “file log” signaling devices or the like.

3. The security system of claim 2, wherein said at least one notification system may send said notifications and/or an alarm to other hosts and/or clients of said information network.

4. The security system of claim 1, wherein it comprises a programmable board comprising at least one processor, on said at least one processor there being installed at least one operating system and at least one software:
adapted to the control of said received data packets,
capable of acting on said means for cutting-off the electrical supply of said one or more of said hosts and/or clients connected to said security system, and
settable for any said notifications.

5. The security system of claim 4, wherein on said processor of said programmable board one or more “false server processes” that act as “honeypots” may be provided, said “false server processes” consisting in programs and/or services that act as target for said attack and/or cyber threat.

6. The security system of claim 1, wherein said means for cutting-off the electric supply for said one or more hosts and/or clients connected thereto comprise a relay, said relay being connected to said programmable board and comprising a normally closed switch, the detection of said attack and/or threat resulting in the opening of said switch.

7. The security system of claim 1, wherein said electric supply means thereof may comprise:
at least one port comprising a seat for a connector for the connection to the mains, and/or
one or more batteries, possibly rechargeable.

8. The security system of claim 1, wherein said means for the connection to said information network comprise at least one port for a network cable and/or Wi Fi® or Bluetooth® modules.

9. The security system of claim 1, wherein it comprises a key for manually opening and/or resetting said switch of the relay.

10. The security system of claim 1, wherein it is of the type capable of communicating via network and/or special known communication protocols to other hosts and/or clients to start their security and shutdown procedures via software.

11. The security system of claim 1, wherein it is “plug & play” and “stand alone”, said system being easily connectable in said information network.

12. Security procedure against an attack and/or cyber threat coming from a software and/or an attacker and carried out over an information network comprising at least one or more hosts and/or one or more clients, said procedure being implementable through the security system of claim 1, wherein it comprises at least the following steps:
receiving one or more data packets;
checking whether said data packet represent a threat;
energetically disconnecting at least one or more of said hosts and/or clients of said information network (R) in case of attack and/or detected cyber threat;
said procedure allowing to identify an attack and/or cyber threat already during the scanning and/or enumeration of the active IP addresses in the information network operated by said software and/or attacker.

13. The security procedure of claim 12, wherein it further comprises the step of notification of the detected threat.

14. The security procedure of claim 12, wherein it communicates via network and/or special known communication protocols to other hosts and/or clients of said information network to start their security and shutdown procedures via software.
